(19) United States
(12) Patent Application Publication
(10) Pub. No.: US 2024/0070643 A1
(43) Pub. Date: Feb. 29, 2024

(54) ACCOUNT TRANSFER BY VIRTUAL ASSISTANT

(71) Applicant: Truist Bank, Charlotte, NC (US)

(72) Inventors: Yadhira Haydee Arroyo, Chicago, IL (US); Alex Heath Misiaszek, Cornelius, NC (US); William Hawks, Charlotte, NC (US); LaTonja Barlow, Lenexa, KS (US)

(73) Assignee: Truist Bank, Charlotte, NC (US)

(21) Appl. No.: 17/896,473

(22) Filed: Aug. 26, 2022

(51) Int. Cl. G06Q 20/32; G06Q 20/14

(52) U.S. Cl. CPC G06Q 20/326; G06Q 20/14; G06Q 20/3276

(57) ABSTRACT

A process of receiving, through a virtual assistant application, a request made by a user to transfer funds from a user account. The process may involve requesting, through the virtual assistant application, that the user identify a user account from which to transfer the funds and identify a receiving account to which the funds are transferred. The process may further involve attempting to transfer the funds from the user account to the receiving account and reporting, through the virtual assistant application, a result of an attempted transfer of the funds.

### TECHNICAL FIELD

The present disclosure relates generally to funds transfers and, more particularly (although not necessarily exclusively), to funds transfer initiated through a virtual assistant.

### BACKGROUND

Payment cards, such as credit cards and debit cards, enable users to efficiently transfer funds. A payment card may be electronically linked to an account or accounts belonging to the user. These accounts may be deposit accounts, loan or credit accounts, and the card may be a means of authenticating the user. Users may have limited control over the operation of the payment cards during transactions, and locations that accept payment cards during a payment transaction may be limited.

### SUMMARY

In an example, a non-transitory computer-readable includes instructions that are executable by a processing device to cause the processing device to perform operations. The operations include receiving, through a virtual assistant application, a request made by a user to transfer funds from an account. The operations also include requesting, through the virtual assistant application, that the user identify a user account from which to transfer the funds and identify a receiving account to which the funds are transferred. Additionally, the operations include attempting to transfer the funds from the user account to the receiving account. Further, the operations include reporting, through the virtual assistant application, a result of an attempted transfer of the funds.

In an additional example, a computer-implemented method includes receiving, through a virtual assistant application, a request made by a user to transfer funds from a user account. Additionally, the method includes requesting, through the virtual assistant application, that the user identify a user account from which to transfer the funds and identify a receiving account to which the funds are transferred. Further, the method includes attempting to transfer funds from the user account to the receiving account and reporting, through the virtual assistant application, a result of an attempted transfer of funds.

In an additional example, a system includes a processor and a non-transitory computer-readable medium including instructions that are executable by a processing device to cause the processing device to perform operations. The operations include receiving, through a virtual assistant application, a request made by a user to transfer funds from an account. The operations also include requesting, through the virtual assistant application, that the user identify a user account from which to transfer the funds and identify a receiving account to which the funds are transferred. Additionally, the operations include attempting to transfer the funds from the user account to the receiving account. Further, the operations include reporting, through the virtual assistant application, a result of an attempted transfer of the funds.

### BRIEF DESCRIPTION OF THE DRAWINGS

FIG. 1 is a schematic of a banking environment in which a user can execute a funds transfer via a virtual assistant according to one example of the present disclosure.

FIG. 2 is a block diagram of an example computing device according to one example of the present disclosure.

FIG. 3 is a flow chart of an example of a process for implementing some aspects of the present disclosure.

### DETAILED DESCRIPTION

Certain aspects and examples of the present disclosure relate to electronic funds transfers made through a virtual assistant. A virtual assistant may be a software application used to conduct a conversation via text or text-to-speech in place of direct contact with a live human agent. A virtual assistant may interpret natural language entered by a user to navigate an algorithm that may be arranged to execute a plurality of possible outcomes.

A banking customer may want to execute an electronic funds transfer without using an automated teller machine (ATM), without interacting with a teller at a physical bank location, without accessing a banking website, or without accessing a typical banking application for a mobile phone. For example, a banking customer may want to transfer funds to an account of a familial relative. With a typical banking application for a mobile phone, the banking customer may have to manually enter an account number or review a transaction history to find an account number to transfer funds to their relative. By using a virtual assistant to execute the funds transfer to the relative, the banking customer may be able to remain in a messaging interface that may have capabilities that the typical banking application may not offer. For example, the process may be streamlined with fewer required interaction points than a process associated with a transfer through other techniques. For example, the banking customer may instruct the virtual assistant to send the familial relative a given amount of funds. The banking customer may not need to enter the account number or the full name of the relative. The virtual assistant may be able to search the smartphone of the banking customer to find the contact information of the relative to facilitate the transfer and may also review past transactions to determine if a similar transaction was conducted in the past. These actions may enable the virtual assistant to identify the correct familial relative and a correct account associated with the familial relative. The virtual assistant may enable speech-to-text functionality where the banking customer can execute the funds transfer by spoken commands and responses read aloud by the virtual assistant application.

The virtual assistant may enable a level of control over fund transfers which may otherwise require an elevated level of familiarity with a banking website, typical banking application, or other means of electronic fund transfer. For example, a banking customer may wish to automatically deposit a portion of their paycheck into a savings account until a certain savings goal has been reached. The banking customer may be able to describe the boundaries of the reoccurring transfer without needing to know where an esoteric user interface sub-menu is accessed for automatically stopping recurring transfers based on certain variables.

The virtual assistant application may be accessible from a smartphone application, from a web browser, from an ATM, or from any other suitable electronic device. The virtual assistant may receive any combination of text commands or verbal commands. The virtual assistant may supply the user with open ended questions or with multiple choice questions. The user's response may cause the virtual assistant to navigate an algorithm that may include processes for electronically transferring funds. The virtual assistant may prompt the client to perform actions such as taking a picture of a check with a smartphone. The virtual assistant may send the user notifications via a smartphone operating system.

The virtual assistant application may enable a user to transfer funds within a user's own accounts. The virtual assistant application may enable a user to transfer funds to other accounts. The virtual assistant application may enable a user to transfer funds to satisfy an obligation, such as paying a bill. The virtual assistant application may enable a user to transfer funds to a transfer of cash at a cash office. The virtual assistant application may enable a user to transfer funds to a stored-value money card, such as a gift card telephone card, or voucher.

The virtual assistant may respond to questions about transfer histories. For example, a user may be able to inquire how much money has been transferred to a given account over a given timespan. Alternatively, the user may be able to inquire if they have an outstanding balance or other obligation before requesting a transfer of funds.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

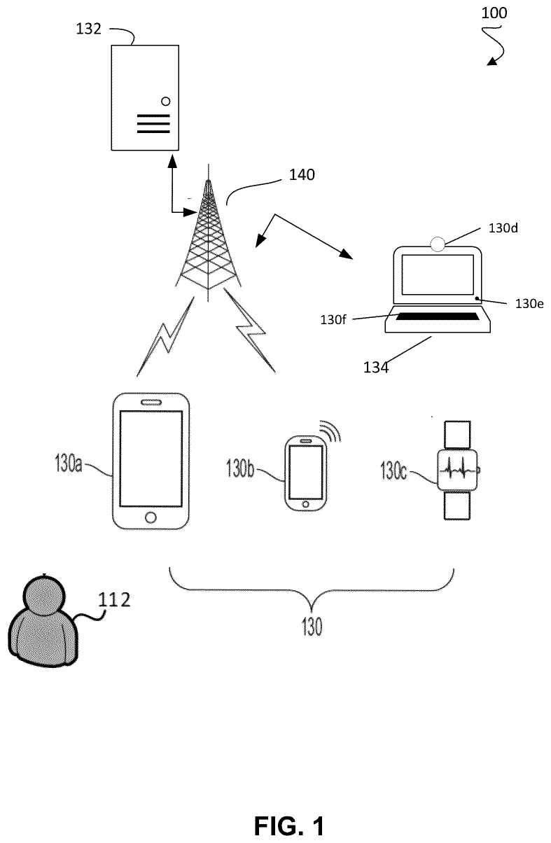

FIG. 1 is a schematic of a banking environment 100 in which a user 112 can execute a funds transfer via a virtual assistant according to one example of the present disclosure. Included in the banking environment 100 are the user 112, one or more sensing devices 130, one or more communication networks 140, a computing device 134, and a banking server 132. The one or more sensing devices 130 and the computing device 134 may send or receive communication with the banking server 132 over the one or more communication networks 140. The one or more communication networks 140 may correspond to one or more Wide Area Networks (“WANs”), such as the Internet, through which the one or more sensing devices 130, the computing device 134, and the banking server 132 may communicate with other servers via web browsers or client-side applications, to establish communication sessions, request and receive web-based resources, and access other features of applications or services.

The one or more sensing devices 130, which can include suitable sensor devices for accessing web-based resources or application-based resources, can be capable of accessing and establishing communication sessions with the banking server 132 through the one or more communication networks 140. As illustrated in FIG. 1, sensing devices 130a-130c correspond to mobile devices, including tablet computers 130a, smartphones 130b, and smart watches 130c, which may access the banking server 132 via a Local Area Network (“LAN”) or Wide Area Network (“WAN”), as well as mobile telecommunication networks, short-range wireless networks, or various other communication network types (e.g., cable or satellite networks). Sensing devices 130d-130f correspond to sensing devices associated with the computing device 134, including a camera 130d, a microphone 130e, and a keyboard 130f. Although certain examples herein are described in terms of mobile devices, in other examples, the one or more sensing devices 130 may additionally or alternatively include other mobile or non-mobile devices (e.g., desktop computers, laptop computers, and the like) capable of accessing the banking server 132 via the one or more communications networks 140. The one or more sensing devices 130 and the computing device 134 can be capable of recording audio or video of a user action.

Additional examples of the sensing devices 130 can include smart speakers such as a Sonos® One®, Amazon® Echo®, Apple® HomePod®, or Google® Nest. Examples of the sensing devices 130 can also include smart appliances such as smart refrigerators, or home robots such as an Amazon® Astro or iRobot® Roomba®. Additionally, the sensing devices 130 may rely on various virtual environments, such as the Metaverse by Meta, or other device ecosystems to perform some of the operations described herein.

The one or more sensing devices 130 can detect a gesture from the user 112. The computing device 134 can receive input from the user 112. The input to the computing device 134 can include a user's PIN, a passcode, or a fake PIN. The banking server 132 can receive notification of the gesture an intent of the gesture from the one or more sensing devices 130. In some examples, the input to the computing device 134 can verify the intent of the gesture from the user 112. For example, a pre-determined code that is not a normal PIN code for the user 112 may confirm the gesture intent. The banking server 132 can receive the input from the user from the computing device 134 and can control personal banking operations based on the input.

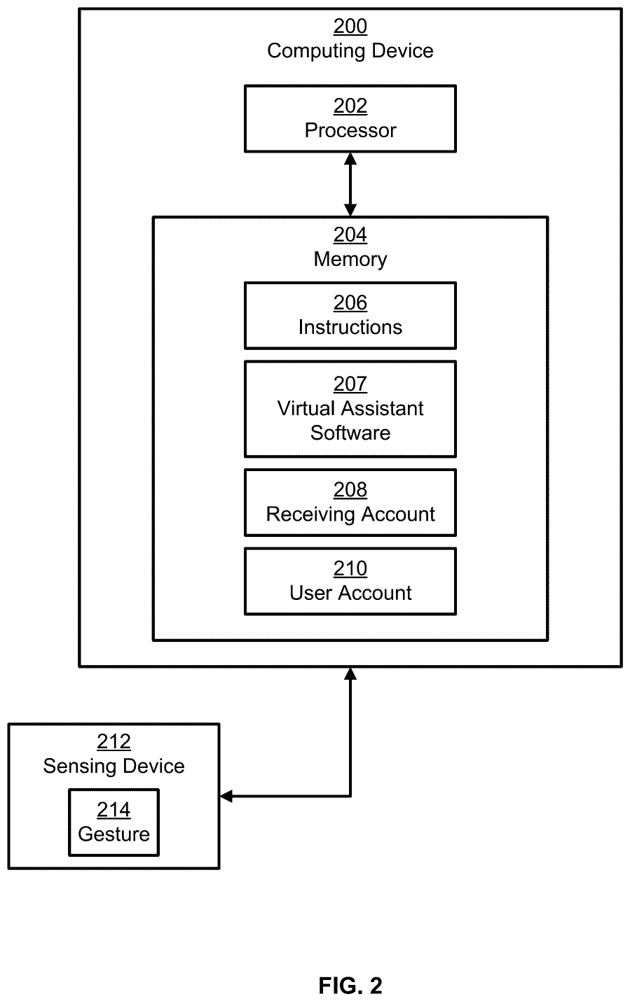

FIG. 2 is a block diagram of an example computing device 200 according to one example of the present disclosure. The computing device 200 includes a processor 202 that is communicatively coupled to a memory 204. In some examples, the processor 202 and the memory 204 may be distributed from (e.g., remote to) one another. The processor 202 can include one processing device or multiple processing devices. Non-limiting examples of the processor 202 include a Field-Programmable Gate Array (FPGA), an application-specific integrated circuit (ASIC), a microprocessor, etc. The processor 202 can execute instructions 206 stored in the memory 204 to perform operations. In some examples, the instructions 206 can include processor-specific instructions generated by a compiler or an interpreter from code written in a suitable computer-programming language, such as C, C++, C#, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can include a non-transitory, computer-readable medium form which the processor 202 can read instructions 206. A computer-readable medium can include electronic, optical, magnetic, or other storage devices capable of providing the processor 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

The memory 204 may also contain information about a receiving account 208 and a user account 210. The user account 210 may be any account from which a user is authorized to transfer funds. Examples of the user account 210 may include a checking account, a savings account, a money-market account, a line of credit, a stored-value money card, a voucher account, an individual retirement account, a defined-contribution account, an expense account, any joint account, or any other suitable account.

The receiving account 208 may be any account to which the user is authorized to transfer funds. Examples of the receiving account 208 may include a checking account, a savings account, a money-market account, a line of credit, a stored-value money card, a voucher account, an individual retirement account, a defined-contribution account, an expense account, a credit card cash-back benefits account such as an account associated with a Truist® Enjoy Cash® credit card, any joint account, or any other suitable account. Examples of the receiving account 208 may also include stored-value money cards, transfers of cash to a cash office, transfers to a digital distribution platform such as the Apple® App Store®, Google® Play® Store, Sony® Playstation Store, Microsoft @ Store, Steam®, Nintendo @eShop®, Amazon® Prime®, Audible®, or any other suitable digital distribution platform. Examples of the receiving account 208 may include unsecured debts such as credit card bills, medical bills, personal loans, and student loans. In some examples, a receiving account 208 or a user account 210 may be for a virtual currency such as miles for a frequent-flyer program, cryptocurrency, or fictional currency such as an in-game currency in a video game.

The memory 204 may contain virtual assistant software 207. The virtual assistant software 207 may guide a user through an algorithm related to an electronic transfer of funds. The virtual assistant software 207 may guide a user through additional algorithms related to other banking services, such as transfers, deposits, or inquiries about transactions. The virtual assistant software 207 may recognize natural language in the form of text or voice commands and assign inputs, such as numerical values or decision node values, to the natural language. Example decision nodes may include a type of banking service requested by the virtual assistant 207, such as a transfer, a deposit, or an inquiry about a transaction.

The computing device 200 may be communicatively coupled to a sensing device 212. The sensing device may be a touchscreen, a number pad, a keyboard, a graphics tablet, a point of sales device, a camera, an accelerometer, a gyroscope, a magnetometer, an ultrasonic transducer, a subsonic transducer, an infrared input, a servomotor, a microphone, or any combination of buttons, switches, dials, sliders, or touch sensor strips. Additional examples of the sensing device 212 can include smart speakers such as a Sonos® One®, Amazon® Echo®, Apple @HomePod®, or Google @ Nest. Examples of the sensing device 212 can also include smart appliances such as smart refrigerators, or home robots such as an Amazon® Astro or iRobot® Roomba®. Additionally, the sensing device 212 may rely on various virtual environments, such as the Metaverse by Meta, or other device ecosystems to perform some of the operations described herein.

The sensing device 212 may detect a gesture 214. The gesture 214 may provide instructions for a banking system to execute any command necessary for transferring funds via virtual assistant 207. The gesture 214 may be include multiple actuations of any of the aforementioned examples of a sensing device 212. The gesture 214 may include any combination of actuations of the aforementioned examples of a sensing device 212.

The gesture 214 may be any gesture recognized by a gesture system, such as OneUI released by Samsung. The gesture 214 may be at least one swipe, tap, or drawn shape entered into a touchscreen, wherein the touchscreen is the sensing device 212. The gesture 214 may be a duration dependent interaction with a touchscreen, such as contacting a portion of a touchscreen for a period of time or moving a finger, fingers, a stylus, or other suitable means of interaction across a touchscreen at a controlled pace. The gesture 214 may require a combination of physical inputs on a touchscreen at the same time, such as a pinching or spreading motion between fingers.

The gesture 214 may be defined as navigating to an icon or user interface item. The icon or user interface item may be intentionally mislabeled to maintain privacy. The gesture 214 may involve inputs into the buttons or switches of a smartphone, tablet, laptop computer, or similar device. The gesture 214 may involve inputs into the buttons or switches of a device communicatively coupled a smartphone, tablet, laptop computer, or similar device. For example, a transaction executed primarily through a smartphone may be privately flagged by a series of inputs into the volume buttons of a headset in communication with the smartphone.

The gesture 214 may be at least one accelerometer input, gyroscopic input, magnetometer input, ultrasonic input, subsonic input, infrared input, or motion control input from the smartphone, smartwatch, laptop computer, or other suitable device. For example, the gesture 214 may involve shaking a smartphone or tapping a portion of a smartphone that is not the touchscreen. The gesture 214 may be at least one accelerometer input from a device communicatively coupled to the smartphone, smartwatch, laptop computer, or other suitable device. For example, the gesture 214 may be movement detected from a communicatively coupled headset or earphones.

The gesture 214 may be a motion or behavior displayed in view of a camera of a smartphone, laptop computer, ATM security camera, or other suitable device. The gesture 214 may be a code word, code phrase, or any other suitable utterance. The gesture 214 may be an interaction with a servomotor.

The gesture 214 may be a combination of any of the aforementioned example gestures. For example, the gesture 214 may be a shape drawn on the screen of a smartphone while a volume button of the smartphone is depressed.

The gesture 214 may be the use of an alternate PIN, an alternate username, or an alternate password. The gesture 214 may be an alteration to a signature entered into a signature field displayed on a screen.

The gesture 214 may be periodically updated from a prompt issued to a user by the computing device 200. For example, the computing device 200 may instruct a user to enter a new gesture every three months.

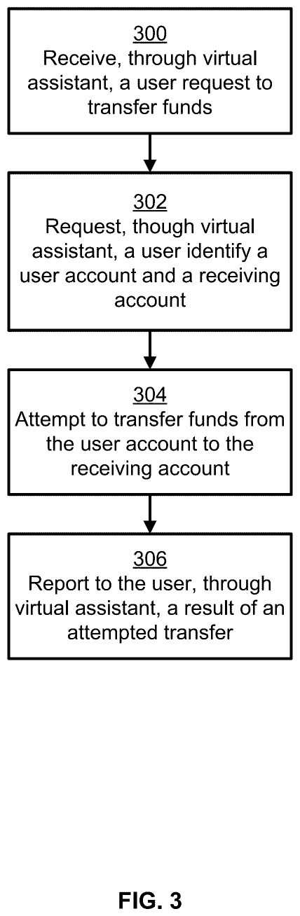

FIG. 3 is a flow chart of an example of a process for implementing some aspects of the present disclosure. In block 300, the computing device 200 may receive a request made by a user to transfer funds from an account. The request may be issued by text or by at least one spoken command that is provided to a virtual assistant 207. The request may contain various instructions for the transfer of funds. For example, the request may contain instructions to execute the transfer at a given time, to execute the transfer on a recurring schedule, to execute the transfer until a given parameter is satisfied, or to execute the transfer only after a given parameter is satisfied. An example of executing the transfer until a given parameter is satisfied may involve transferring a given amount of funds into a specified account on a recurring schedule until the specified account reaches a certain account balance. An example of executing the transfer only after a given parameter is satisfied may involve transferring a given amount of funds only after the account from which the funds are transferred meets or exceeds a certain account balance.

In block 302, the computing device 200, through the virtual assistant 207, may request the user identify the user account 210 from which to transfer the funds, if not already provided in the initial request made by the user. Examples of the user account 210 may include a checking account, a savings account, a money-market account, a line of credit, a stored-value money card, a voucher account, an individual retirement account, a defined-contribution account, an expense account, any joint account, or any other suitable account. In some examples, an image of a check, voucher, title, deed, or any other suitable financial instrument may serve to identify the user account 210. In some examples, the user may specify multiple accounts from which to transfer funds. The user account 210 may be identified by biometrics, such as facial recognition, thumbprint, or voice recognition.

The computing device 200 may, using the virtual assistant 207, ask the user to identify a receiving account 208 to which the bank is authorized to transfer the funds. Examples of the receiving account 208 may include a checking account, a savings account, a money-market account, a line of credit, a stored-value money card, a voucher account, an individual retirement account, a defined-contribution account, an expense account, a credit card cash-back benefits account such as an account associated with a Truist® Enjoy Cash® credit card, any joint account, or any other suitable account. Examples of the receiving account 208 may also include stored-value money cards, transfers of cash to a cash office, transfers to a digital distribution platform such as the Apple® App Store®, Google® Play® Store, Sony® Playstation Store, Microsoft @ Store, Steam®, Nintendo® eShop®, Amazon® Prime®, Audible®, or any other suitable digital distribution platform. Examples of the receiving account 208 may include bills and unsecured debts such as credit card bills, medical bills, personal loans, and student loans. In some examples, a receiving account 208 may be for a virtual currency such as miles for a frequent-flyer program, cryptocurrency, or fictional currency such as an in-game currency in a video game.

The receiving account 208 may be an account held by the user or an account held by any other entity. The receiving account 208 may be identified by a quick response code, a scanned blank check, a barcode, or any other suitable identifier. The receiving account 208 may be identified by biometrics, such as facial recognition, thumbprint, or voice recognition.

In block 304, the computing device 200 may attempt to transfer funds from the user account 210 to the receiving account 208. The computing device 200 may evaluate the balance of the user account 210 in executing the attempt. For example, the computing device 200 may prevent or alter the transfer of funds if the user account 210 has either insufficient funds or if executing the transfer would violate a user specified condition. An example of a user specified condition may be a minimum account balance or a user specified order for executing transactions or satisfying obligations. The computing device 200 may evaluate the receiving account 208 in executing the attempt. An example of the computing device 200 evaluating the receiving account 208 may be comparing the receiving account 208 to resources such as Glassdoor®, the Better Business Bureau®, Angie's List®, or any other suitable resource that may be useful for evaluating a reputation of an entity associated with the receiving account 208. In some examples, the computing device 200 may issue a message to the user, based on an evaluation of the receiving account 208, asking them to confirm execution of the transfer in light of any discoveries made by the aforementioned example evaluations.

In block 306, the computing device 200 may, using the virtual assistant 207, report to the user a result of the attempted transfer. In the event a transfer does not execute, the computing device 200 may also issue an explanation as to why the transfer did not execute. The computing device 200 may suggest an alternative transfer to request in the event a transfer does not execute. For example, a user may attempt to pay a utility bill using their checking account. The checking account may have an insufficient balance to pay the utility bill. The computing device 200 may suggest the user pay the utility bill by transferring a combination of funds from both the checking account and a savings account.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer-readable medium comprising instructions that are executable by a processing device to cause the processing device to:
receive, through a virtual assistant application, a request made by a user to transfer funds from a user account;
request, through the virtual assistant application, that the user identify a user account from which to transfer the funds and identify a receiving account to which the funds are transferred;
attempt to transfer the funds from the user account to the receiving account; and
report, through the virtual assistant application, a result of an attempted transfer of the funds.

2. The non-transitory computer-readable medium of claim 1, wherein the request made by the user is converted from a speech input to a textual representation of the request through the virtual assistant application.

3. The non-transitory computer-readable medium of claim 1, wherein the receiving account comprises a second user account.

4. The non-transitory computer-readable medium of claim 1, wherein the user account comprises a line of credit, and the request comprises a request to transfer the funds from a line of credit cash advance of the line of credit to the receiving account.

5. The non-transitory computer-readable medium of claim 1, wherein the request comprises an interpretation of at least one recognized gesture input by the user at a smartphone, wherein the at least one recognized gesture comprises a gesture corresponding to a particular request of a transfer of the funds from the user account to the receiving account.

6. The non-transitory computer-readable medium of claim 1, further comprising instructions that are executable by the processing device to cause the processing device to:
interpret a quick response code to identify the receiving account.

7. The non-transitory computer-readable medium of claim 1, wherein the receiving account comprises a payment account to resolve a bill.

8. A method comprising:
receiving, through a virtual assistant application, a request made by a user to transfer funds from a user account;
requesting, through the virtual assistant application, that the user identify a user account from which to transfer the funds and identify a receiving account to which the funds are transferred;
attempting to transfer the funds from the user account to the receiving account; and
reporting, through the virtual assistant application, a result of an attempted transfer of the funds.

9. The method of claim 8, wherein the receiving account is a second user account.

10. The method of claim 8, further comprising asking the user, via the virtual assistant application, to transfer funds from a line of credit cash advance to the receiving account.

11. The method of claim 8, wherein the request comprises an interpretation of at least one recognized gesture input by the user at a smartphone, wherein the at least one recognized gesture comprises a gesture corresponding to a particular request of a transfer of the funds from the user account to the receiving account.

12. The method of claim 8, wherein the request made by the user is converted from a speech input to a textual representation of the request through the virtual assistant application.

13. The method of claim 8, wherein the receiving account comprises a payment account to resolve a bill.

14. The method of claim 8, further comprising interpreting a quick response code to identify the receiving account.

15. A system comprising:
a processor; and
a non-transitory computer-readable medium comprising instructions that are executable by a processing device to cause the processing device to:
receive, through a virtual assistant application, a request made by a user to transfer funds from a user account;
request, through the virtual assistant application, that the user identify a user account from which to transfer the funds and identify a receiving account to which the funds are transferred;
attempt to transfer the funds from the user account to the receiving account; and
report, through the virtual assistant application, a result of an attempted transfer of the funds.

16. The system of claim 15, wherein the receiving account comprises a second user account.

17. The system of claim 15, wherein the user account comprises a line of credit, and the request comprises a request to transfer the funds from a line of credit cash advance of the line of credit to the receiving account.

18. The system of claim 15, wherein the request made by the user is converted from a speech input to a textual representation of the request through the virtual assistant application.

19. The system of claim 15, wherein the non-transitory computer-readable medium further comprises instructions that are executable by the processor to cause the processor to:
interpret a quick response code to identify the receiving account.

20. The system of claim 15, wherein the receiving account comprises a payment account to resolve a bill.
